(19) United States
(12) Patent Application Publication
(10) Pub. No.: US 2025/0019303 A1
(43) Pub. Date: Jan. 16, 2025

(54) BRICK POWDER AS A FILLER IN MULTI-COMPONENT SYSTEMS FOR CHEMICAL FASTENING

(71) Applicant: Hilti Aktiengesellschaft, Schaan (LI)

(72) Inventors: Beate Gnass, Gersthofen (DE); Georg Nickerl, Diessen am Ammersee (DE); Thomas Bürgel, Landsberg (DE); Memet-Emin Kumru, Augsburg (DE)

(73) Assignee: Hilti Aktiengesellschaft, Schaan (LI)

(21) Appl. No.: 18/708,359

(22) PCT Filed: Oct. 26, 2022
(86) PCT No.: PCT/EP2022/079875

§ 371 Date: May 8, 2024

(30) Foreign Application Priority Data
Nov. 9, 2021 (EP) 21207140.1

(51) Int. Cl. C04B 18/167; C04B 22/06; C04B 26/06; C04B 103/14

(52) U.S. Cl. CPC C04B 18/167; C04B 22/068; C04B 26/06; C04B 2103/14

(57) ABSTRACT

A reactive resin component (A) for a multi-component system and a multi-component system for chemically fastening construction elements containing brick powder as a filler can be made. The use of brick powder as a filler in the reactive resin component (A) increases the performance of a fastening arrangement which has a mortar mass prepared from the multi-component system and a fastening means when the mortar mass is applied into a borehole filled with water.

The present invention relates to a reactive resin component (A) based on radically curable compounds for a multi-component system and to a multi-component system for the chemical fastening of construction elements containing brick powder as a filler. The use of brick powder as a filler in the reactive resin component (A) increases the performance of a fastening arrangement which comprises a mortar mass prepared from the multi-component system according to the invention and a fastening means in which the mortar mass is applied into a borehole filled with water.

### BACKGROUND

The use of reaction resin components based on radically polymerizable compounds to prepare chemical dowels has been known for a long time in a wide range of fields, including construction.

Chemical dowels are regularly used both in indoor and outdoor areas. Setting an anchoring point thus takes place under a wide variety of conditions and influences. The conditions and influences under which the chemical dowel is introduced into the borehole should as far as possible not have any negative effects on the load level of the cured chemical dowel.

A situation frequently occurring on a construction site is the setting of an anchor rod in the case of rainfall. In these cases, the borehole to be filled with the mortar mass is filled with water. In the usual two-component systems for the preparation of a chemical dowel that are commercially available, a borehole filled with water regularly leads to a reduction of the load level of the chemical dowel during the setting process.

There is therefore a need for providing multi-component systems for preparing chemical dowels of which the load level is not negatively influenced by a borehole filled with water during the setting process. The load values to be achieved should be at least comparable to the load values of chemical dowels prepared from conventional multi-component systems based on radically curing compounds.

### DESCRIPTION OF THE INVENTION

Surprisingly, it has been found that when brick powder was used as a filler in a reactive resin component (A) of a multi-component system based on radically curable compounds, it was possible to improve the bond strength of the cured mortar mass compared to comparable mortar masses without the addition of brick powder.

A first subject matter of the invention is a reactive resin component (A) based on radically curable compounds for a multi-component system containing brick powder as a filler.

A second subject matter of the invention is a multi-component system containing the reactive resin component (A) according to the invention according to claim 10.

A third subject matter of the invention is the use of brick powder in a multi-component system according to claim 14 for increasing the performance of a fastening arrangement, in which the mortar mass prepared from the multi-component system was applied to a borehole filled with water.

Within the meaning of the invention:
“Brick powder” means a powder obtained by grinding bricks. The term “brick” within the meaning of the present invention is understood to mean all masonry bricks within the meaning of DIN EN 771-1. Accordingly, masonry bricks are masonry stones which are fired from clay or other clay-containing substances with or without sand or other additives at a sufficiently high temperature in order to achieve a ceramic compound. The term “masonry stone” is understood to mean a preformed element for producing masonry. Alternatively or in combination with masonry bricks, it is also possible to use roof tiles for producing the brick powder.
“Reactive resin mixture” means a mixture of a radically curable compound, one or more inhibitors, one or more reactive diluents and optionally further additives; the reactive resin mixture is typically liquid or viscous and can be further processed to form a reactive resin component;
“inhibitor” means a substance which suppresses unwanted radical polymerization during the synthesis or storage of a resin or a resin-containing composition (these substances are also referred to in the art as “stabilizers”), or which delays radical polymerization of a resin after an initiator has been added, usually in conjunction with an accelerator (these substances are also referred to in the art as “inhibitors”; the particular meaning of the term becomes clear from the context);
“initiator” means a substance which (usually in combination with an accelerator) forms reaction-initiating radicals;
“accelerator” means a reagent which reacts with the initiator so that larger quantities of radicals are prepared by the initiator even at low temperatures, or which catalyzes the decomposition reaction of the initiator;
“reactive diluents” means liquid or low-viscosity monomers and backbone resins which dilute other backbone resins or the reactive resin masterbatch and thereby impart the viscosity necessary for application thereof, which contain functional groups capable of reacting with the backbone resin, and which for the most part become a constituent of the cured mass (e.g., of the mortar) during polymerization (curing); reactive diluents are also referred to as co-polymerizable monomers;
“reactive resin component” means a liquid or viscous mixture of reactive resin, fillers, reactive diluents and optionally further components, e.g., fillers, additives; typically, the reactive resin component is one of the two components of a two-component reactive resin system for chemical fastening;
“hardener component” means a composition containing an initiator for the polymerization of a radically curable compound; the hardener component may be solid or liquid and may contain, in addition to the initiator, a solvent and fillers and/or additives; typically, the hardener component, in addition to the reactive resin component, is the other of the two components of a two-component reactive resin system for chemical fastening;
“two-component system” or “two-component reactive resin system” means a reactive resin system comprising two separately stored components, a reactive resin component (A) and a hardener component (B), so that the backbone resin contained in the reactive resin component is cured only after the two components are mixed;
“multi-component system” or “multi-component reactive resin system” means a reactive resin system comprising a plurality of separately stored components, including a reactive resin component (A) and a hardener component (B), so that the backbone resin contained in the reactive resin component is cured only after all of the components are mixed;
“(meth)acryl . . . / . . . (meth)acryl . . . ” means both the “methacryl . . . / . . . methacryl . . . ” and the “acryl . . . / . . . acryl . . . ” compounds; “methacryl . . . / . . . methacryl . . . ” compounds are preferred in the present invention;
“epoxy (meth)acrylate” means an epoxy resin which has acrylate groups or methacrylate groups and is substantially free of epoxy groups;
“alkyl” means a saturated hydrocarbon functional group that can be branched or unbranched; preferably a C₁-C₇ alkyl, particularly preferably a C₁-C₄ alkyl, i.e. an alkyl selected from the group consisting of methyl, ethyl, n-propyl, iso-propyl, n-butyl, iso-butyl, and tert-butyl; methyl, ethyl and tert-butyl are particularly preferred and methyl is very particularly preferred;
“hydroxyalkyl” means an alkyl carrying at least one hydroxyl group as a substituent;
“alkenyl” means an unsaturated hydrocarbon functional group having at least one double bond, which can be branched or unbranched; preferably a C₂-C₂₀ alkenyl, particularly preferably a C₂-C₆ alkenyl; i.e. an alkenyl selected from the group consisting of ethenyl, propenyl, butenyl, pentenyl and hexenyl; ethenyl, propenyl and butenyl are particularly preferred, and ethenyl is very particularly preferred;
“alkynyl” means an unsaturated hydrocarbon functional group having at least one triple bond, which can be branched or unbranched; preferably a C₂-C₂₀ alkynyl, particularly preferably a C₂-C₆ alkynyl, i.e. an alkynyl selected from the group consisting of ethynyl, propynyl, butynyl, pentynyl and hexynyl; ethynyl, propynyl and butynyl are particularly preferred, and ethenyl is very particularly preferred;
“cold curing” means that a reactive resin system can cure completely at room temperature;
“a” or “an” as the article preceding a class of chemical compounds, e.g., preceding the word “epoxy methacrylate”, means that one or more compounds included in this class of chemical compounds, e.g., various epoxy methacrylates, may be intended. In a preferred embodiment, this article means only a single compound;
“at least one” means numerically “one or more.” In a preferred embodiment, the term numerically means “one”;
“contain”, “comprise” and “include” mean that further constituents may be present in addition to those mentioned. These terms are intended to be inclusive and therefore also encompass “consist of.” “Consist” of is intended to be exclusive and means that no further constituents may be present. In a preferred embodiment, the terms “contain”, “comprise” and “include” mean the term “consist of”;
“approximately” or “approx.” before a numerical value means a range of ±5% of this value, preferably ±2% of this value, more preferably ±1% of this value, particularly preferably ±0% of this value (i.e. exactly this value).

All standards cited in this text (e.g., DIN standards) were used in the version that was current on the filing date of this application.

### Brick Powder as a Filler

According to the present invention, the reactive resin component (A) according to the present invention comprises brick powder as a filler.

The term “brick powder” within the meaning of the present invention describes a powder or granules obtained by comminution or grinding of masonry bricks. Hammer breakers are usually used for comminuting and/or grinding the masonry bricks.

Following the grinding process, the brick powder is usually subjected to a sieving process. By choosing the sieve(s) having a defined mesh width in the sieving process, the particle size of the brick powder used is set to a defined particle size range. For example, the brick powder has particles having a size of 0.5 mm (particle size range >0 to 0.5 mm) when using a sieve having a mesh size of 0.5 mm. However, due to the different orientation of the particles of the brick powder during the sieving process, it is also possible for a small proportion of the particles to be greater than the mesh width of the sieve. This occurs in particular in the case of asymmetrically shaped particles (for example rod-shaped). In order to take account of this circumstance, the so-called d₉₀ value is used for the specification of the particle size in the context of the present invention. The d₉₀ value is a parameter indicating that 90% of the sample volume has a smaller particle size than the specified value. It is important for the present invention that the particle size of the remaining 10% of the sample volume is not arbitrarily large, since this leads to problems in the processability of the mortar mass. Preferably, the particles of the brick powder used have a maximum particle diameter of 2 mm, preferably 1.5 mm, even more preferably 1.0 mm. The d₉₀ value in the context of the present invention is determined by means of static light scattering (device: Beckman Coulter LS 13 320/Dry Powder System).

The brick powder used according to the invention as filler preferably has a d₉₀ value of ≤0.90 mm, more preferably 0.85 mm, further preferably ≤0.80 mm. In a particularly preferred embodiment, the brick powder has a d₉₀ value in a range of 0.9 mm to 0.2 mm, preferably in a range of 0.85 mm to 0.25 mm, more preferably in a range of 0.80 mm to 0.25 mm.

The smallest particles of the brick powder used preferably have a particle diameter of ≥0.1 μm, more preferably of a ≥0.3 μm.

To produce the brick powders to be used according to the invention, sieves having a mesh width in a range of 0.20 mm to 0.90 mm, preferably from 0.20 to 0.85 mm, more preferably 0.25 mm to 0.80 mm, are preferably used in the sieving process.

The brick powders to be used according to the invention are commercially available, for example, from Pilosith GmbH,Peter Stadler GmbH or Kalkladen GmbH.

Preferably, the brick powder has a water content of less than 1.0 wt. %, preferably less than 0.2 wt. %. To reduce the water content, the brick powder is typically dried at 120° C. in an oven for 48 hours.

Preferably, the reactive resin component (A) comprises at least 10 wt. % of brick powder based on the total weight of the reactive resin component. The brick powder is preferably contained in the reactive resin component (A) according to the invention in a weight percentage proportion of 10 to 70 wt. % based on the total weight of the reactive resin component, in particular in a proportion of 20 to 60 wt. %, even more preferably in a proportion of 20 to 50 wt. %.

In a further embodiment of the invention, the brick powder can additionally also be contained in the hardener component (B), but it is preferred that the hardener component (B) is free of brick powder.

### Reactive Resin

The reactive resin component (A) comprises at least one radically curable compound as a reactive resin. Ethylenically unsaturated compounds, compounds having carbon-carbon triple bonds, and thiol-yne/ene resins, as are known to a person skilled in the art, are suitable as radically curable compounds.

Of these compounds, the group of ethylenically unsaturated compounds is preferred, which group comprises styrene and derivatives thereof, (meth)acrylates, vinyl esters, unsaturated polyesters, vinyl ethers, allyl ethers, itaconates, dicyclopentadiene compounds and unsaturated fats, of which unsaturated polyester resins and vinyl ester resins are particularly suitable and are described, for example, in the applications EP 1 935 860 A1, DE 195 31 649 A1 and WO 10/108939 A1. Vinyl ester resins are in this case most preferred due to the hydrolytic resistance and excellent mechanical properties thereof.

Examples of suitable unsaturated polyesters are divided into the following categories:
(1) ortho-resins: these are based on phthalic anhydride, maleic anhydride or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol A;
(2) iso-resins: these are prepared from isophthalic acid, maleic anhydride or fumaric acid and glycols. These resins can contain higher proportions of reactive diluents than the ortho resins;
(3) bisphenol A fumarates: these are based on ethoxylated bisphenol A and fumaric acid;
(4) HET acid resins (hexachloroendomethylene tetrahydrophthalic acid resins): these are resins obtained from chlorine/bromine-containing anhydrides or phenols during the preparation of unsaturated polyester resins.

In addition to these resin classes, what are referred to as dicyclopentadiene resins (DCPD resins) can also be distinguished as unsaturated polyester resins. The class of DCPD resins is either obtained by modifying one of the above-mentioned resin types by means of a Diels-Alder reaction with cyclopentadiene, or said resins are alternatively obtained by means of a first reaction of a diacid, for example maleic acid, with dicyclopentadiene and then by means of a second reaction of the usual preparation of an unsaturated polyester resin, the latter being referred to as a DCPD maleate resin.

The unsaturated polyester resin preferably has a molecular weight Mn in the range of 500 to 10,000 daltons, more preferably in the range of 500 to 5000 and even more preferably in the range of 750 to 4000 (according to ISO 13885-1). The unsaturated polyester resin has an acid value in the range of 0 to 80 mg KOH/g resin, preferably in the range of 5 to 70 mg KOH/g resin (according to ISO 2114-2000). If a DCPD resin is used as the unsaturated polyester resin, the acid value is preferably 0 to 50 mg KOH/g resin.

Within the meaning of the invention, vinyl ester resins are oligomers or polymers having at least one (meth)acrylate end group, what are referred to as (meth)acrylate-functionalized resins, which also include urethane (meth)acrylate resins and epoxy (meth)acrylates.

Vinyl ester resins, which have unsaturated groups only in the end position, are obtained, for example, by reacting epoxy oligomers or epoxy polymers (for example bisphenol A digylcidyl ether, phenol novolac-type epoxies or epoxy oligomers based on tetrabromobisphenol A) with (meth)acrylic acid or (meth)acrylamide, for example. Preferred vinyl ester resins are (meth)acrylate-functionalized resins and resins which are obtained by reacting epoxy oligomers or polymers with methacrylic acid or methacrylamide, preferably with methacrylic acid. Examples of compounds of this kind are known from the applications U.S. Pat. Nos. 3,297,745 A, 3,772,404 A, 4,618,658 A, GB 2217722 A1, DE 3744390 A1 and DE 4131457 A1. In this context, reference is made to the application US 2011/071234.

The vinyl ester resin preferably has a molecular weight Mn in the range of 500 to 3,000 daltons, more preferably 500 to 1,500 daltons (according to ISO 13885-1). The vinyl ester resin has an acid value in the range of 0 to 50 mg KOH/g resin, preferably in the range of 0 to 30 mg KOH/g resin (according to ISO 2114-2000).

Ethoxylated bisphenol A di(meth)acrylate having a degree of ethoxylation of 2 to 10, preferably of 2 to 4, difunctional, trifunctional or higher functional urethane (meth)acrylate oligomers, or mixtures of these curable constituents are particularly suitable as the vinyl ester resin.

Examples of epoxy(meth)acrylates of this kind are those of formula (I)

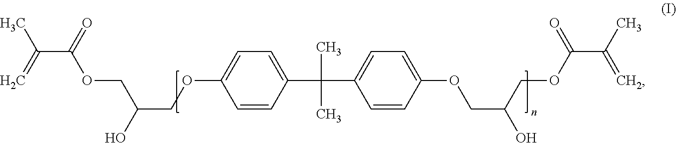

where n represents a number greater than or equal to 1 (if mixtures of different molecules are present with different n values and are represented by formula (I), non-integer numbers are also possible as average).

Further examples of the propoxylated or in particular ethoxylated aromatic diol, such as bisphenol A, bisphenol F or novolac (in particular di-)(meth)acrylates, are those of formula (II)

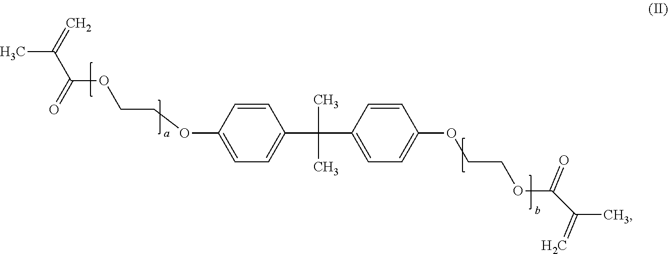

where a and b each independently represent a number greater than or equal to 0 with the proviso that preferably at least one of the values is greater than 0, preferably both 1 or greater (if mixtures of different molecules having different (a and b) values are present and are represented by the formula (II), non-integer numbers are also possible as the average value).

The known reaction products of di- or polyisocyanates and hydroxyalkylmethylacrylates, as described, for example, in DE 2 312 559 A1, adducts of (di)isocyanates and 2,2-propane bis[3-(4-phenoxy)-1,2-hydroxypropane-1-methacrylate] according to US-PS 3 629 187, and the adducts of isocyanates and methacryloyl alkyl ethers, alkoxybenzenes or alkoxycycloalkanes, as described in EP 44352 A1, are very particularly suitable. In this context, reference is made to DE 2312559 A1, DE 19902685 A1, EP 0684906 A1, DE 4111828 A1 and DE 19961342 A1. Of course, mixtures of suitable monomers can also be used.

All of these resins that can preferably be used according to the invention can be modified according to methods known to a person skilled in the art, for example to achieve lower acid numbers, hydroxide numbers or anhydride numbers, or can be made more flexible by introducing flexible units into the backbone, and the like.

In addition, the reactive resin may contain other reactive groups that can be polymerized with a radical initiator, such as peroxides, for example reactive groups derived from itaconic acid, citraconic acid and allylic groups and the like, as described, for example, in WO 2010/108939 A1 (itaconic acid ester).

The proportion of the reactive resin in the reactive resin component is preferably from approx. 10 to approx. 70 wt. %, more preferably from approx. 20 to approx. 60 wt. %, even more preferably from approx. 25 to approx. 50 wt. %, based on the reactive resin component.

### Reactive Diluent

The reactive resin component (A) can contain suitable reactive diluents, as are described in the applications EP 1 935 860 A1 and DE 195 31 649 A1. Preferably, the reactive resin component (A) contains, as the reactive diluent, a (meth)acrylic acid ester, wherein particularly preferably aliphatic or aromatic C₅-C₁₅-(meth)acrylates are selected. Suitable examples comprise: 2-, 3-hydroxypropyl(meth)acrylate (HP(M)A), 1,3-propanediol di(meth)acrylate, 1,3-butanediol di(meth)acrylate, 1,4-butanediol di(meth)acrylate, trimethylolpropane tri(meth)acrylate, phenethyl (meth)acrylate, tetrahydrofurfuryl (meth)acrylate, N,N-dimethylaminoethyl (meth)acrylate, N,N-dimethylaminomethyl (meth)acrylate, acetoacetoxyethyl (meth)acrylate, isobornyl (meth)acrylate, 2-ethylhexyl (meth)acrylate, methoxypolyethylene glycol mono(meth)acrylate, trimethylcyclohexyl (meth)acrylate, 2-hydroxyethyl (meth)acrylate, dicyclopentenyloxyethyl (meth)acrylate and/or tricyclopentadienyl di(meth)acrylate, bisphenol A (meth)acrylate, novolac epoxy di(meth)acrylate, di-[(meth)acryloyl-maleoyl]-tricyclo-5.2.1.0.^{2.6}-decane, dicyclopentenyloxyethylcrotonate, 3-(meth)acryloyl-oxymethyl-tricylo-5.2.1.0.^{2.6}-decane, 3-(meth)cyclopentadienyl (meth)acrylate, and decalyl-2-(meth)acrylate; solketal (meth)acrylate, cyclohexyl (meth)acrylate, phenoxyethyl di(meth)acrylate, methoxyethyl (meth)acrylate, tert-butyl (meth)acrylate and norbornyl (meth)acrylate. Methacrylates are preferred over acrylates. Particularly preferred are 2- and 3-hydroxypropyl methacrylate (HPMA), 1,2-ethanediol dimethacrylate, 1,4-butanediol dimethacrylate (BDDMA), 1,3-butanediol dimethacrylate, trimethylolpropane trimethacrylate, acetoacetoxyethyl methacrylate, isobornyl methacrylate, bisphenol A methacrylate, trimethylcyclohexyl methacrylate, 2-hydroxyethyl methacrylate, PEG200 dimethacrylate and norbornyl methacrylate. 1,4-Butanediol dimethacrylate and a mixture of 2- and 3-hydroxypropyl methacrylate (HPMA), or a mixture of these three methacrylates, are very particularly preferred. A mixture of 2- and 3-hydroxypropyl methacrylate (HPMA) is most preferred. In principle, other conventional radically polymerizable compounds, alone or in a mixture with the (meth)acrylic acid esters, can also be used as reactive diluents, e.g., styrene, α-methylstyrene, alkylated styrenes, such as tert-butylstyrene, divinylbenzene and vinyl and allyl compounds, of which the representatives that are not subject to mandatory labeling are preferred. Examples of vinyl or allyl compounds of this kind are hydroxybutyl vinyl ether, ethylene glycol divinyl ether, 1,4-butanediol divinyl ether, trimethylolpropane divinyl ether, trimethylolpropane trivinyl ether, mono-, di-, tri-, tetra- and polyalkylene glycol vinyl ether, mono-, di-, tri-, tetra- and polyalkylene glycol allyl ether, adipic acid divinyl ester, trimethylolpropane diallyl ether and trimethylolpropane triallyl ether.

The reactive diluents are preferably present in the reactive resin in an amount to approx. 80 wt. %, particularly preferably from approx. 10 to approx. 60 wt. %, even more preferably from approx. 30 to approx. 60 wt. %, based on the reactive resin component (A).

### Inhibitors

One or more inhibitors can be present in the reactive resin component (A) according to the invention, both for stabilizing the reactive resin or the reactive resin component (A) containing the reactive resin, and for adjusting the resin reactivity.

The inhibitors usually used for radically polymerizable compounds, as are known to a person skilled in the art, are suitable for this purpose. These inhibitors are preferably selected from phenolic inhibitors and non-phenolic inhibitors, in particular phenothiazines.

Phenols such as 2-methoxyphenol, 4-methoxyphenol, 2,6-di-tert-butyl-4-methylphenol, 2,4-di-tert-butylphenol, 2,6-di-tert-butylphenol, 2,4,6-trimethylphenol, 2,4,6-tris(dimethylaminomethyl)phenol, 4,4′-thio-bis(3-methyl-6-tert-butylphenol), 4,4′-isopropylidenediphenol, 6,6′-di-tert-butyl-4,4′-bis(2,6-di-tert-butylphenol), 1,3,5-trimethyl-2,4,6-tris(3,5-di-tert-butyl-4-hydroxybenzyl)benzene, 2,2′-methylene-di-p-cresol, catechols such as pyrocatechol, and catechol derivatives such as butylpyrocatechols such as 4-tert-butylpyrocatechol and 4,6-di-tert-butylpyrocatechol, hydroquinones such as hydroquinone, 2-methylhydroquinone, 2-tert-butylhydroquinone, 2,5-di-tert-butylhydroquinone, 2,6-di-tert-butylhydroquinone, 2,6-dimethylhydroquinone, 2,3,5-trimethylhydroquinone, benzoquinone, 2,3,5,6-tetrachloro-1,4-benzoquinone, methylbenzoquinone, 2,6-dimethylbenzoquinone, naphthoquinone, or mixtures of two or more thereof, are suitable as phenolic inhibitors. These inhibitors are often a constituent of commercial radically curing reactive resin components.

Phenothiazines such as phenothiazine and/or derivatives or combinations thereof, or stable organic radicals such as galvinoxyl and N-oxyl radicals, in particular of the piperidinyl-N-oxyl or tetrahydropyrrole-N-oxyl type, are preferably considered as non-phenolic inhibitors, such as aluminum-N-nitrosophenylhydroxylamine, diethylhydroxylamine, oximes such as acetaldoxime, acetone oxime, methyl ethyl ketoxime, salicyloxime, benzoxime, glyoximes, dimethylglyoxime, acetone-O-(benzyloxycarbonyl)oxime, TEMPOL, TEMPO and the like.

Furthermore, pyrimidinol or pyridinol compounds substituted in para-position to the hydroxyl group, as described in DE 10 2011 077 248 E1, can be used as inhibitors.

Examples of stable N-oxyl radicals which can be used are those described in DE 199 56 509 A1 and DE 195 31 649 A1. Stable nitroxyl radicals of this kind are of the piperidinyl-N-oxyl or tetrahydropyrrole-N-oxyl type or a mixture thereof.

Preferred stable nitroxyl radicals are selected from the group consisting of 1-oxyl-2,2,6,6-tetramethylpiperidine, 1-oxyl-2,2,6,6-tetramethylpiperidin-4-ol (also referred to as TEMPOL), 1-oxyl-2,2,6,6-tetramethylpiperidin-4-one (also referred to as TEMPON), 1-oxyl-2,2,6,6-tetramethyl-4-carboxyl-piperidine (also referred to as 4-carboxy-TEMPO), 1-oxyl-2,2,5,5-tetramethylpyrrolidine, 1-oxyl-2,2,5,5-tetramethyl-3-carboxylpyrrolidine (also referred to as 3-carboxy-PROXYL) and mixtures of two or more of these compounds, with 1-oxyl-2,2,6,6-tetramethylpiperidin-4-ol (TEMPOL) being particularly preferred.

The inhibitor or inhibitors are preferably selected from the group consisting of N-oxyl radicals, catechols, catechol derivatives and phenothiazines and a mixture of two or more thereof. The inhibitor or inhibitors selected from the group consisting of Tempol, catechols and phenothiazines are particularly preferred. The inhibitors used in the examples are very particularly preferred, preferably approximately in the amounts stated in the examples.

The inhibitors can be used either alone or as a combination of two or more thereof, depending on the desired properties of the reactive resin. The combination of phenolic and non-phenolic inhibitors is preferred.

The inhibitor or inhibitor mixture is added in conventional amounts known in the art, preferably in an amount of approximately 0.0005 to approximately 2 wt. % (based on the reactive resin, which is ultimately prepared therewith), more preferably from approximately 0.01 to approximately 1 wt. % (based on the reactive resin), even more preferably from approximately 0.05 to approximately 1 wt. % (based on the reactive resin).

### Hardener Component (B)

A hardener is used for curing the radically curable compound.

A hardener system is preferably used which comprises the hardener and an accelerator.

The accelerator of the reactive resin component (A) can be added here.

The curing of the reactive resin can be initiated with a peroxide as an initiator.

Accordingly, in one embodiment, the hardener system contains
at least one accelerator customarily used for curing with peroxides, and
a peroxide as initiator.

Any of the peroxides known to a person skilled in the art that are used to cure epoxy (meth)acrylate resins can be used. Such peroxides comprise organic and inorganic peroxides, either liquid or solid, with it also being possible to use hydrogen peroxide. Examples of suitable peroxides are peroxycarbonates (of formula —OC(O)OO—), peroxyesters (of formula —C(O)OO—), diacyl peroxides (of formula —C(O)OOC(O)—), dialkyl peroxides (of formula —OO—), hydroperoxides (of formula —OOH), and the like. These can be present as oligomers or polymers. A comprehensive set of examples of suitable peroxides is described, for example, in the application US 2002/0091214 A1, paragraph [0018].

The peroxides are preferably selected from the group of organic peroxides. Suitable organic peroxides are: tertiary alkyl hydroperoxides such as tert-butyl hydroperoxide and other hydroperoxides such as cumene hydroperoxide, peroxyesters or peracids such as tert-butyl peresters (e.g., tert-butyl peroxybenzoate), benzoyl peroxide, peracetates and perbenzoates, lauroyl peroxide including (di)peroxyesters, perethers such as peroxy diethyl ether, perketones, such as methyl ethyl ketone peroxide. The organic peroxides used as hardeners are often tertiary peresters or tertiary hydroperoxides, i.e., peroxide compounds having tertiary carbon atoms which are bonded directly to an —O—O-acyl or —OOH group. However, mixtures of these peroxides with other peroxides can also be used according to the invention. The peroxides may also be mixed peroxides, i.e., peroxides which have two different peroxide-carrying units in one molecule. In a preferred embodiment, benzoyl peroxide (BPO) or tert-butyl peroxybenzoate is used for curing.

The peroxide can be used in its pure form or as a constituent of a mixture. It is typically used as a constituent of a mixture, in particular as a constituent of a hardener component (B) of a reactive resin system, as is described in greater detail further below. The hardener component used in the examples or a hardener component having the same constituents is particularly preferred.

The use of organically substituted ammonium persulfates (for example N′N′N′N′-tetrabutylammonium or N′N′N′-tricapryl-N′-methylammonium persulfate is also possible.

In addition to the peroxide, the hardener system can also contain a phlegmatizer in order to stabilize the peroxide. Corresponding phlegmatizers are known from DE 3226602 A1, EP 0432087 A1 and EP 1 371 671 A1.

Such a hardener system preferably contains water as a phlegmatizer. In addition to the water, the hardener system can also contain further phlegmatizers, water being preferred as the sole phlegmatizer in order not to introduce any compounds which have a softening effect.

The peroxide is preferably present as a suspension together with the water. Corresponding suspensions are commercially available in different concentrations, such as the aqueous dibenzoyl peroxide suspensions from United Initiators (e.g., BP40SAQ), Perkadox 40L-W (Nouryon), Luperoxg® EZ-FLO (Arkema), Peroxan BP40W (Pergan).

The hardener component can contain the peroxide in an amount of 0.25 to 35 wt. %, preferably 1 to 30 wt. %, particularly preferably 5 to 25 wt. %, based on the hardener component.

In the hardener system described, an accelerator is used in addition to the peroxide. This accelerates the hardening reaction. This accelerator is added to the reactive resin component in order to store it spatially separated from the peroxide and thus prevent its premature decomposition.

Suitable accelerators are known to a person skilled in the art. These are expediently amines.

Suitable amines are selected from the following compounds, which are described in the application US 2011071234 A1, for example: dimethylamine, trimethylamine, ethylamine, diethylamine, triethylamine, n-propylamine, di-n-propylamine, tri-n-propylamine, isopropylamine, diisopropylamine, triisopropylamine, n-butylamine, isobutylamine, tert-butylamine, di-n-butylamine, diisobutylamine, triisobutylamine, pentylamine, isopentylamine, diisopentylamine, hexylamine, octylamine, dodecylamine, laurylamine, stearylamine, aminoethanol, diethanolamine, triethanolamine, aminohexanol, ethoxyaminoethane, dimethyl(2-chloroethyl)amine, 2-ethylhexylamine, bis(2-chloroethyl)amine, 2-ethylhexylamine, bis(2-ethylhexyl)amine, N-methylstearylamine, dialkylamines, ethylenediamine, N,N′-dimethylethylenediamine, tetramethylethylenediamine, diethylenetriamine, permethyldiethylenetriamine, triethylenetetramine, tetraethylenepentamine, 1,2-diaminopropane, di-propylenetriamine, tripropylenetetramine, 1,4-diaminobutane, 1,6-diaminohexane, 4-amino-1-diethylaminopentane, 2,5-diamino-2,5-dimethylhexane, trimethylhexamethylenediamine, N,N-dimethylaminoethanol, 2-(2-diethylaminoethoxy)ethanol, bis(2-hydroxyethyl)oleylamine, tris[2(2-hydroxyethoxy)ethyl]amine, 3-amino-1-propanol, methyl(3-aminopropyl)ether, ethyl-(3-aminopropyl)ether, 1,4-butanediol-bis(3-aminopropyl ether), 3-dimethylamino-1-propanol, 1-amino-2-propanol, 1-diethylamino-2-propanol, di-iso-propanolamine, methyl-bis(2-hydroxypropyl)amine, tris(2-hydroxypropyl)amine, 4-amino-2-butanol, 2-amino-2-methylpropanol, 2-amino-2-methylpropanediol, 2-amino-2-hydroxymethylpropanediol, 5-diethylamino-2-pentanone, 3-methylaminopropionitrile, 6-aminohexanoic acid, 11-aminoundecanoic acid, 6-aminohexanoic acid ethyl ester, 11-aminohexanoate-isopropyl ester, cyclohexylamine, N-methylcyclohexylamine, N,N-dimethylcyclohexylamine, dicyclohexylamine, N-ethylcyclohexylamine, N-(2-hydroxyethyl)cyclohexylamine, N,N-bis(2-hydroxyethyl)cyclohexylamine, N-(3-aminopropyl)cyclohexylamine, aminomethylcyclohexane, hexahydrotoluidine, hexahydrobenzylamine, aniline, N-methylaniline, N,N-dimethylaniline, N,N-diethylaniline, N,N-dipropylaniline, isobutylaniline, toluidine, diphenylamine, hydroxyethylaniline, bis(hydroxyethyl)aniline, chloroaniline, aminophenols, aminobenzoic acids and esters thereof, benzylamine, dibenzylamine, tribenzylamine, methyldibenzylamine, α-phenylethylamine, xylidine, di-iso-propylaniline, dodecylaniline, aminonaphthalene, N-methylaminonaphthalene, N,N-dimethylaminonaphthalene, N,N-dibenzylnaphthalene, diaminocyclohexane, 4,4′-diamino-dicyclohexylmethane, diamino-dimethyl-dicyclohexylmethane, phenylenediamine, xylylenediamine, diaminobiphenyl, naphthalenediamines, benzidines, 2,2-bis(aminophenyl)propane, aminoanisoles, aminothiophenols, aminodiphenyl ethers, aminocresols, morpholine, N-methylmorpholine, N-phenylmorpholine, hydroxyethylmorpholine, N-methylpyrrolidine, pyrrolidine, piperidine, hydroxyethylpiperidine, pyrroles, pyridines, quinolines, indoles, indolenines, carbazoles, pyrazoles, imidazoles, thiazoles, pyrimidines, quinoxalines, aminomorpholine, dimorpholineethane, [2,2,2]-diazabicyclooctane and N,N-dimethyl-p-toluidine.

Preferred amines are symmetrically or asymmetrically substituted aniline and toluidine derivatives and N,N-bis(hydroxy)alkylarylamines, such as N,N-dimethylaniline, N,N-diethylaniline, N,N-dimethyl-p-toluidine, N,N-bis(hydroxyalkyl)arylamines, N,N-bis(2-hydroxyethyl)aniline, N,N-bis(2-hydroxyethyl)toluidine, N,N-bis(2-hydroxypropyl)aniline, N,N-bis(2-hydroxypropyl)toluidine, N,N-bis(3-methacryloyl-2-hydroxypropyl)-p-toluidine, N,N-dibutoxyhydroxypropyl-p-toluidine, N-methyl-N-hydroxyethyl-p-toluidine, N-ethyl-N-hydroxyethyl-p-toluidine and the analog o- or m-toluidines and 4,4′-bis(dimethylamino)diphenylmethane and/or the leuco forms of the dyes crystal violet or malachite green.

Polymeric amines, such as those obtained by polycondensation of N,N-bis(hydroxyalkyl)aniline with dicarboxylic acids or by polyaddition of ethylene oxide and these amines, are also suitable as accelerators.

Preferred accelerators are N,N-bis(2-hydroxypropyl)toluidine, N,N-bis(2-hydroxyethyl)toluidine and para-toluidine ethoxylate (Bisomer@ PTE).

In this, preferred, embodiment, the reactive resin component can contain the accelerator in an amount of 0.01 to 10 wt. %, preferably 0.1 to 5 wt. %, particularly preferably 0.1 to 3 wt. %, based on the resin component.

Alternatively, a hardener system which is peroxide-free can be used for the curing, which system contains the following constituents:
at least one manganese compound as an accelerator and
a 1,3-dioxo compound as an initiator.

For this purpose, reference is made to DE 10 2011 078 785 A1.

Suitable 1,3-dioxo compounds are compounds of the general formula (III)

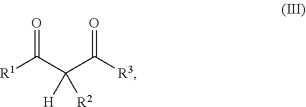

where
R¹ and R³ are in each case each independently an unbranched or branched,
optionally substituted C₁-C₄ alkyl group or a C₁-C₄ alkoxy group,
R² is an unbranched or branched, optionally substituted C₁-C₄ alkyl group or a C₁-C₄ alkoxy group, or together with R¹ or R³ forms an optionally substituted five- or six-membered aliphatic ring, which optionally comprises heteroatoms in or on the ring.

In this hardener system it is essential that, in the compound of the formula (III), the carbon atom which bonds the two carbonyl groups to one another has exactly one hydrogen atom bonded to this carbon atom.

The compound of the general formula (III) is preferably a compound of the formula (IV)

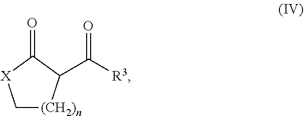

where independently X=C, O, n=1, 2 and R³ is an unbranched or branched, optionally substituted C₁-C₄ alkyl group or a C₁-C₄ alkoxy group. X is more preferably O. n is more preferably 1. R³ is more preferably a C₁-C₄ alkyl group.

Particularly preferably, the compound of the formula (III) is 2-methyl-2,4-pentanedione, α-acetyl butyrolactone, cyclopentanone-2-carboxylic acid ethyl ester or cyclopentane-2-carboxylate, wherein α-acetylbutyrolactone is most preferred.

A manganese compound, in particular a manganese salt or a manganese complex, is used as an accelerator. It is also possible to use mixtures of manganese salts and/or manganese complexes.

Manganese salts or manganese complexes, in particular based on 1,3-dioxo compounds, such as acetylacetonate (petan-2,4-dione), and carboxylic acids such as naphthenates, octoates, ethylhexanoates or saturated fatty acids, have proven particularly suitable. There are no restrictions with regard to the manganese compound. The manganese compound is expediently soluble in nonpolar solvents. Mn(II)octoate is very particularly suitable.

Likewise alternatively, a hardener system which comprises the following constituents can be used for the curing:
at least one metal salt as an accelerator and
at least one compound containing thiol and/or thiol ester groups as an initiator.

As a result of the combination or the mixing of the two constituents, radicals can be formed which, instead of previously customary radical formers, can trigger polymerization of non-aromatic double bonds, for example olefinic double bonds, for example acrylates or methacrylates.

Examples of thiols are thioglycerol, methyl-, ethyl mercaptan and higher homologs, for example dodecyl mercaptan, dimercaptoane, such as dimercaptopropanesulfonic acid, dimercaptosuccinic acid, dithiothreitol, poly(ethylene glycol) dithiole, the general formula HS—[CH ₂—CH₂—O]ₙ—CH₂—CH₂—SH, where n represents a number between 0 to 10; liquid polysulfide polymers with thiol end groups, e.g., Thioplast G types from Akzo Nobel; polymercaptan hardeners and polymercapatan cross-linking agents, e.g., SIQ-Amin 999 from S.I.Q.-Kunstharze GmbH: ethoxylated and/or propoxylated alcohols from mono-, di-, tri-, tetra-, pentaols and/or other polyols with thiol end groups, e.g., Capcure 3-800 from Cognis, or the compounds referred to below as especially suitable thiols. As a particularly suitable thiol ester, mention may be made here of octanethiol acid-S-[3(triethoxysilyl)propyl]ester. Examples of suitable thiols are glycol di (3-mercaptopropionate), trimethylolpropane tri (3-mercaptopropionate), pentaerythritol tetra (3-mercaptopropionate), dipentaerythritol hexa (3-mercaptopropionate), ethoxylated trimethylolpropane tris (3-mercaptopropionate) with different degrees of ethoxylation (e.g., ETTMP 700 and ETTMP 1300 from Bruno Bock), tris[2-(3-mercaptopropionyloxy)ethyl]isocyanurate, 3-mercaptopropyltrimethoxysilane.

As a further alternative, a hardener system which includes the following constituents can be used for the curing:
at least one metal salt as an accelerator and
at least one CH-acidic compound of the formula (V) as an initiator

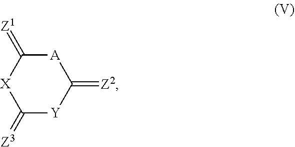

where
(i)
   -A- represents —C(R¹)(R²)—,
   —X— represents a bond, for —NR³— or —(CR⁴R⁵)ₚ—, or —O—,
   Y represents NR⁶ or (CR⁷R⁸)_{q} or O,
   where if X represents O, Y also represents O;
   where preferably X represents (CR⁴R⁵)ₚ and Y represents CR⁷R⁸,
   or X represents NR³ and Y represents NR⁶;
   Z¹ represents O, S, S═O or S(═O)₂,
   Z³ represents O, S, S═O or S(═O)₂,
   Z³ represents O, S, S═O or S(═O) or R⁹ and R¹⁰,
   p represents 1, 2 or 3, preferably 1 or 2
   q represents 1, 2 or 3, preferably 1;
   and the functional groups R¹, R², R³, R⁴, R⁵, R⁶, R⁷, R⁸, R⁹ and R¹⁰ each independently represent hydrogen, alkyl, aryl, aralkyl, cycloalkyl or cycloalkylalkyl and are each unsubstituted or substituted and/or heteroatoms (instead of C atoms; preferably selected from O, N, such as NH or N-alkyl, and S, with the proviso that at least one of the functional groups Wand R² represents hydrogen,
or
(ii) open-chain compounds,
where the link forming the bridge is —C(═Z3)— is missing,
   -A- represents —C(R¹)(R²)—, X and Y each independently represent an in each case unbranched or branched, unsubstituted or substituted C₁-C₄ alkyl group or C₁-C₄ alkoxy group, which optionally has heteroatoms (instead of C atoms; in particular selected from O, N, such as NH or N-alkyl, and S) or preferably represent an in each case unsubstituted or substituted C₁-C₄ alkoxycarbonylmethyl group or a C₁-C₄ alkylcarbonylmethyl group, which optionally has heteroatoms (instead of C atoms; in particular selected from O, N, such as NH or N-alkyl, and S), R¹ and R² are both hydrogen and
   Z¹ and Z² have the above meanings;
   or X represents an in each case unbranched or branched, unsubstituted or substituted C₁-C₄ alkyl group or C₁-C₄-alkoxy group or C₁-C₄ alkoxycarbonylmethyl group or C₁-C₄alkylcarbonylmethyl group, which optionally has heteroatoms (instead of C atoms; in particular selected from O, N, such as NH or N-alkyl, and S),
   Y and Z² together with the binding carbon atom are —CN,
   Z¹ has the above meanings, and
   R¹ and R² in each case as defined above with the proviso that at least one of the functional groups is hydrogen;
   and/or salts thereof.

Preferred examples of such compounds are 2,4,6-pyrimidine trione derivatives are barbituric acids (2,4,6-pyrimidine trione) itself, 1-benzyl-5-phenylbarbituric acid (1-(phenylmethyl)-5-phenyl-2,4,6-pyrimidine trione), 5-butylbarbituric acid (5-butyl-2,4,6-pyrimidine trione), 1-cyclohexyl-5-ethylbarbituric acid (1-cyclohexyl-5-ethyl-2,4,6-pyrimidine trione) or 2-thiobarbituric acid (4,6-dihydroxy-2-mercaptopyrimidine), 1,3-cyclohexanedione, 2-methyl-1,3-cyclohexanedione, 1,3-cyclopentanedione, 2-methyl-1,3-cyclopentanedione, 4,4-dimethyl-1,3-cyclohexanedione, 5,5-dimethyl-1,3-cyclohexanedione (dimedone), 2,2-dimethyl-1,3-dioxane-4,6-dione or 2,2,5-trimethyl-1,3-dioxane-4,6-dione, 3-oxoglutaric acid dimethyl ester, and/or diethyl-1,3-acetone dicarboxylate, ethyl cyanoacetate, methyl cyanoacetate or 2-ethylhexyl cyanoacetate, or 1,3-dioxo compounds mentioned in DE 10 2011 078 785.

In both cases, the components used as accelerators in the form of a metal salt, also including metal complexes and metal oxides, are preferably one or more metal salts or in particular salts of organic and/or inorganic acids with metals, for example selected from cobalt, zirconium, zinc, cerium, tin, bismuth or preferably vanadium, manganese, copper or iron, or mixtures of two or more thereof, wherein the organic acids are preferably saturated, wherein vanadium and iron or in particular manganese and copper, optionally in the presence of one or two co-accelerators having metal content from the group of the abovementioned metals, are preferred, in particular in the form of salts or complexes having inorganic acids and/or carboxylate functional groups, such as carboxylates having CH₃, C₂-C₂₀; alkyl, a C₆-C₂₄ aryl functional group or C₇-C₃₀ aralkyl functional group, for example octanoate, e.g., 2-ethylhexanoate (isooctanoate), further neodecanoate, or acetylacetonate. Particularly preferred are manganese carbonate or carboxylates, such as Mn acetate or Mn octoate, copper carboxylates, such as copper octoate or copper naphthenate, copper quinolates, iron carboxylates, such as iron octoate and/or vanadium carboxylates and/or the group of metal salts having inorganic acids which, for example, comprise iron chloride, iron sulfate and copper chloride.

In a further alternative, a hardening system which comprises the following constituents can be used for the curing:
at least one metal salt as an accelerator and
at least one aldehyde and/or ketone and at least one primary amine as an initiator, and/or
b2) at least one imine which includes one or more imine structural increments of formula (VI):

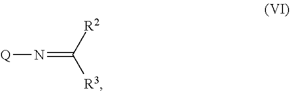

where, each independently:
   Q represents the organic functional group of the amine used (in each case),
   or represents hydrogen; and
   R² and R³ are each independently hydrogen and/or an unsubstituted or substituted, mono- or polybranched or straight-chain organic functional group which optionally has double bonds and/or heteroatoms and which includes at least one aliphatic, heteroaliphatic, alicyclic or heterocyclic molecular structure, or a combination of two or more of the aforementioned molecular structures; and/or salts thereof.

The molecular weight of the imine containing imine structural increments of formula (VI) is preferably 2000 daltons (g/mol) or lower, for example 1000 daltons or lower. The aldehydes and/or ketones each preferably have molecular weights in these ranges.

This hardener system can be present as a finished hardener composition (for example having microencapsulated constituents a) and b)) or can preferably be formed only during the mixture with further constituents of a synthetic resin composition (effectively as a composition (mixture)), for example during use.

The aldehydes, ketones, amines, aldimines or ketimines that are contained or used are known or can be prepared/obtained by processes known per se or are preferably obtained thereafter. The imines can be synthesized or obtained before application (e.g., for fastening anchoring elements) or only “in situ”. Possible processes according to the invention are therefore (t) the separate prior preparation and/or (tt) the “in situ” preparation in which the aldehyde/ketone and the primary amine are divided among different components of the fastening system and are mixed, for example, at the site of application and/or (ttt) the “in situ” preparation in a component of the fastening system in which the aldehyde/ketone and the primary amine are mixed together when preparing the relevant component. In particular, the imines according to (t) are obtained by condensation with elimination of water from one or more amines with one or more aldehydes or ketones. Corresponding reaction conditions for the separate prior conversion (t) are known to a person skilled in the art.

Examples of suitable amines and aldehydes or ketones are found in particular in DE 10 2004 035 542 A1, EP 1 329 469 A1, EP 1 975 190 A1 and EP 2 017 260.

The primary amines which are added as such or for the synthesis of the imines comprise, for example, mono-, di- or polyamines, or mixtures of two or more thereof. The usable mono-, di- and/or polyamines may be both linear and branched. The molecular structure of the mono- and/or di- and/or polyamines may contain aliphatic, heteroaliphatic, alicyclic, heterocyclic, aromatic, aliphatic-aromatic and silane/siloxane molecular structures or two or more independently selected therefrom. Primary and/or secondary and tertiary amino groups can be present in the molecule, but at least one primary amino group (—NH2) must be present in order to form the aldimine or ketimine.

The mono-, di- or polyamines are preferably selected from the group of the alkyl- or alkylene (mono or di)amines (such as e.g.: 2-methylpentanediamine, or 2,2,4- or 2,4,4-trimethylhexamethylenediamine), from the group of the heteroalkyl- or heteroalkylene (mono or di)amines (such as 1,13-diamino-4,7,10-trioxatridecane, commercially available amine-functionalized polyoxyalkylenes [Jeffamine] from Huntsman Corp, or e.g.: triethylenetetramine and/or higher homologs), from the group of the cycloalkyl- or cycloalkylene (mono or di)amines (such as: isophoronediamine, 1,3-bisaminomethylcyclohexane, TCD-diamine), from the group of the heteroalkylalkyl- or heterocycloalkylene (mono or di)amines (such as: aminoethylpiperazine), from the group of the aminols or amino alcohols (such as 1,3-diaminopropane-2-ol), and from the group of the aliphatic-aromatic (mono or di)amines (such as 1,3- or 1,4-benzenedimethanamine), and/or from the group of the aminosilanized fillers.

Further preferably, the mono-, di- or polyamines from the group of the aminoamides, polyaminoamides, Mannich bases and the amine adducts (epoxy-amine adducts as described for example in EP 0 387 418 A2, isocyanate-amine adducts [for example from unreacted amino groups of imine synthesis or from the above-mentioned aminols—when the aminols are used, preferably first of all, the reaction for imine occurs, and subsequently the addition to the isocyanate], Bucherer adducts and Michael Addition adducts).

Aminoalkyl silanes which comprise at least one hydrolyzable group, such as alkoxy, for example methoxy or ethoxy—bonded on the silicon—are also of particular interest as amines. These can hydrolyze and condense (by resulting reaction water or supplied water) and thus form oligomers which carry a plurality of amino groups and meet the REACH definition for polymers. Imines from such aminoalkyl silanes therefore form the basis for particularly preferred embodiments of the invention. Preferred aminoalkyl silanes of this kind are selected, for example, from the group comprising one or more of the following compounds: aminoalkyltri- or dialkoxysilanes, such as 3-aminopropyltrimethoxysilane or 3-aminopropyltriethoxysilane, and N-(aminoalkyl)aminoalkyltri-or-dialkoxysilanes, such as N-(2-aminoethyl)-3-aminopropyltrimethoxysilane or N-(2-aminoethyl)-3-aminopropylmethyldimethoxysilane, further ureidoalkyltrimethoxysilanes, such as 3-ureidopropyltrimethoxysilane.

In a further particular embodiment of the subject matter, aminosilanized fillers which carry primary amino groups, such as aminosilane-treated quartz powder (e.g., Silbond AST(R) from Quarzwerke GmbH), aminosilane-treated siliceous earth (e.g., Aktisil AM(R) from Hoffmann Mineral), or aminosilane-treated fumed silicas, can be provided and included as polyamines.

The aldehydes and ketones which can be used as such or for the synthesis of the aldimines and/or ketimines are in particular those of the formula (VII)

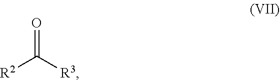

where:
   R², R³ each independently are hydrogen and/or an unsubstituted or substituted and/or a mono- or polybranched or straight-chain organic functional group which optionally has double bonds and/or heteroatoms and which can comprise aliphatic, heteroaliphatic, alicyclic, heterocyclic molecular structures and/or combinations of the aforementioned molecular structures.

Preferably, the aldehydes and/or ketones are compounds which have at least one or more (primary and/or secondary) hydrogen atoms on the alpha carbon atom belonging to the carbonyl group. Examples of such aldehydes are propanal, valeraldehyde, isovaleraldehyde, or methoxyacetaldehyde, or 3,7-dimethyl-6-octenal (citronellal) or 3,7-dimethyl-7-hydroxyoctanal (hydroxycitronellal). Examples of such ketones include methyl isobutyl ketone, acetone, or methyl ethyl ketone or 6-methyl-5-hepten-2-one.

The aldehydes and/or ketones are particularly preferably compounds which have a double bond and/or branching on the alpha carbon atom belonging to the carbonyl group. As a result, the particularly preferred aldehydes and/or ketones only have a (tertiary) hydrogen atom on the alpha carbon atom belonging to the carbonyl group. Examples of particularly preferred aldehydes are isobutyraldehyde, 2-ethylhexanal, 2-methylbutanal, 2-ethylbutanal, 2-methylvaleraldehyde, 2,3-dimethylvaleraldehyde, cyclohexyl carboxaldehyde, or 3,7-dimethyl-2,6-octadiene (citral), 3-(4-tert-butylphenyl)-2-methylpropanal (lilial, lysmeral), tetrahydrofuran-3-carboxaldehyde, tetrahydro-2-furancarboxaldehyde, 4-formyltetrahydropyran, tetrahydro-2H-pyran-2-carbaldehyde or tetrahydro-pyran-3-carbaldehyde. Examples of particularly preferred ketones include diisopropyl ketone, 3-methyl-2-pentanone, 2-methylcyclohexanone or beta-ionone.

The aforementioned examples for suitable amines, preferred and particularly preferred aldehydes and/or ketones are not intended to limit the scope of suitable amines, aldehydes and/or ketones, but rather show only some examples of compounds having the above-mentioned structural features for illustration, which features are defined as suitable, preferred and particularly preferred.

The aldehydes, ketones or synthesized aldimines and/or ketimines mentioned in the examples and the specific amines, ketones and aldehydes, or mixtures of two or more thereof, which are added as such and/or used for the synthesis of the aldimines and/or ketimines, or mixtures of two or more thereof, are also particularly preferred.

Furthermore, the reactive resin component (A) may contain customary fillers and/or additives. It should be noted that some substances can be used both as a filler and, optionally in modified form, as an additive. For example, fumed silica is preferably used as a filler in its polar, non-after-treated form, and is preferably used as an additive in its non-polar, after-treated form. In cases in which exactly the same substance can be used as a filler or an additive, its total amount should not exceed the upper limit for fillers that is determined herein.

In order to prepare a reactive resin component for construction applications, in particular for chemical fastening, further conventional fillers can be added to the reactive resin in addition to the brick powder used according to the invention. These fillers are typically inorganic fillers, as described below for example.

The total proportion of the fillers (brick powder and conventional fillers) and additives is preferably from approx. 50 to approx. 80 wt,%, more preferably from approx. 55 to approx. 75 wt. %, even more preferably from approx. 60 to approx. 70 wt. %, based on the reactive resin component.

### Conventional (Further) Fillers

In addition to the brick powder used according to the invention, the fillers used are conventional fillers, preferably mineral or mineral-like fillers, such as quartz, glass, sand, quartz sand, quartz powder, porcelain, corundum, ceramics, talc, silica (e.g., fumed silica, in particular polar, non-after-treated fumed silica), silicates, aluminum oxides (e.g., alumina), clay, titanium dioxide, chalk, barite, feldspar, basalt, aluminum hydroxide, granite or sandstone, polymeric fillers such as thermosets, hydraulically curable fillers such as gypsum, quicklime or cement (e.g., aluminate cement (often referred to as alumina cement) or Portland cement), metals such as aluminum, carbon black, and also wood, mineral or organic fibers, or the like, or mixtures of two or more thereof. The fillers may be present in any desired shapes, for example as powder, or as shaped bodies, e.g., having a cylindrical, annular, spherical, platelet, rod, saddle or crystal shapes, or else shaped like fiber (fibrillar fillers), and the corresponding base particles preferably have a maximum diameter of approximately 10 mm and a minimum diameter of approximately 1 nm. This means that the diameter is approximately 10 mm or any value less than approximately 10 mm, but more than approximately 1 nm. The maximum diameter is preferably a diameter of approximately 5 mm, more preferably approximately 3 mm, even more preferably approximately 0.7 mm. A maximum diameter of approximately 0.5 mm is very particularly preferred. The more preferred minimum diameter is approximately 10 nm, even more preferably approximately 50 nm, very particularly preferably approximately 100 nm. Diameter ranges resulting from a combination of this maximum diameter and minimum diameter are particularly preferred. However, the globular, inert substances (spherical shape) have a preferred and more pronounced reinforcing effect. Core-shell particles, preferably having a spherical shape, can also be used as fillers.

Preferred fillers are selected from the group consisting of cement, silica, quartz, quartz sand, quartz powder, and mixtures of two or more thereof. For the reactive resin component (A), fillers selected from the group consisting of cement, fumed silica, in particular untreated, polar fumed silica, quartz sand, quartz powder, and mixtures of two or more thereof are particularly preferred.

### Additives

Further possible additives are also rheology additives, such as optionally organically or inorganically after-treated fumed silica (if not already used as a filler), in particular fumed silica after-treated in a non-polar manner, bentonites, alkyl- and methylcelluloses, castor oil derivatives or the like, plasticizers, such as phthalic or sebacic acid esters, stabilizers, antistatic agents, thickening agents, flexibilizers, hardening catalysts, rheological aids, wetting agents, coloring additives, such as dyes or in particular pigments, for example for different staining of the components for improved control of the mixing thereof, or the like, or mixtures of two or more thereof. Agents for regulating pH, such as inorganic and/or organic acids according to DE102010008971A1, in particular copolymers having acidic groups, e.g. esters of phosphoric acid, can also be used. Non-reactive diluents (solvents) such as lower-alkyl ketones, e.g., acetone, di-lower-alkyl lower-alkanoyl amides such as dimethylacetamide, lower-alkylbenzenes such as xylenes or toluene, phthalic acid esters or paraffins, or water, or glycols can also be present, preferably in an amount of up to 30 wt. %, based on the relevant component (reactive resin mortar, hardener), for example from 1 to 20 wt. %. Furthermore, agents for improving the compatibility between the resin component and the hardener component can also be used, such as ionic, nonionic or amphoteric surfactants; soaps, wetting agents, detergents; polyalkylene glycol ethers; salts of fatty acids, mono- or diglycerides of fatty acids, sugar glycerides, lecithin; alkane sulfonates, alkylbenzene sulfonates, fatty alcohol sulfates, fatty alcohol polyglycol ethers, fatty alcohol ether sulfates, sulfonated fatty acid methyl esters; fatty alcohol carboxylates; alkyl polyglycosides, sorbitan esters, N-methyl glucamides, sucrose esters; alkyl phenols, alkyl phenol polyglycol ethers, alkyl phenol carboxylates; quaternary ammonium compounds, esterguats, carboxylates of quatemary ammonium compounds.

Furthermore, metal scavengers in the form of surface-modified fumed silicas can be contained in the reactive resin component. Preferably, at least one thixotropic agent is present as an additive, particularly preferably an organically or inorganically after-treated fumed silica, very particularly preferably a fumed silica after-treated in a non-polar manner, e.g., fumed silica after-treated with polydimethylsiloxane (PDMS), particularly preferably the fumed silica used in the examples which is after-treated in a non-polar manner.

In this regard, reference is made to the applications WO 02/079341 and WO 02/079293 as well as WO 2011/128061 A1.

In one embodiment, the reactive resin component may additionally contain an adhesion promoter. By using an adhesion promoter, the cross-linking of the borehole wall with the mortar mass is improved such that the adhesion increases in the hardened state. This is important for the use of a two-component dowel compound, e.g., in boreholes drilled with a diamond drill, and increases the failure bond strength. Suitable adhesion promoters are selected from the group of silanes which are functionalized with further reactive organic groups and can be incorporated into the polymer network. This group comprises, for example, 3-(meth)acryloyloxypropyltrimethoxysilane, 3-(meth)acryloyloxypropyltriethoxysilane, 3-(meth)acryloyloxymethyltrimethoxysilane, 3-(meth)acryloyloxymethyltriethoxysilane, vinyltrimethoxysilane, vinyltriethoxysilane, functionalized tetraethoxysilane, functionalized tetramethoxysilane, functionalized tetrapropoxysilane, functionalized ethyl or propyl polysilicate, and mixtures of two or more thereof. In this regard, reference is made to application DE 10 2009 059210, the content of which is incorporated herein by reference.

The adhesion promoter is expediently contained in amounts of from approximately 1 to approximately 10 wt. %, based on the total weight of the reactive resin component (A).

Furthermore, it is preferred that the reactive resin component (A) also contains a thixotropic agent, preferably fumed silica after-treated in a non-polar manner, particularly preferably fumed silica after-treated with polydimethylsiloxane (PDMS), very particularly preferably fumed silica after-treated in a non-polar manner.

In a particularly preferred embodiment, the constituents of the reactive resin or of the reactive resin component (A) are one or more of the constituents which are mentioned in the examples according to the invention. Reactive resins or reactive resin components which contain the same constituents or consist of the same constituents as are mentioned in the individual examples according to the invention, preferably approximately in the proportions stated in said examples, are very particularly preferred.

A further subject of the present invention is a multi-component system which comprises a reactive resin component (A) according to the invention and a hardener component (B), wherein the hardener component (B) comprises a hardener for the reactive resin, The multi-component system according to the invention may be in the form of a cartridge system or a film pouch system. In the intended use of the system, the components are either ejected from the cartridges or film pouches under the application of mechanical forces or by gas pressure, are mixed together, preferably by means of a static mixer through which the constituents are passed, and introduced into the borehole, after which the devices to be attached, such as anchor threaded rods and the like, are introduced into the borehole which is provided with the hardening reactive resin, and are adjusted accordingly.

The multi-component system according to the invention is used primarily in the construction sector, for example for the repair of concrete, as polymer concrete, as a synthetic resin-based coating mass or as a cold-hardening road marking. Said system is particularly suitable for chemically fastening anchoring means, such as anchors, reinforcing bars, screws and the like, in boreholes, in particular in boreholes in various substrates, in particular mineral substrates, such as those based on concrete, aerated concrete, brickwork, limestone, sandstone, natural stone, glass and the like, and metal substrates such as those made of steel. In one embodiment, the substrate of the borehole is concrete, and the anchoring means consists of steel or iron. In a further embodiment, the substrate of the borehole is steel, and the anchoring means consists of steel or iron. The multi-component system according to the invention is in particular used to fasten anchoring means in boreholes of a different substrate and for structural bonding. In one embodiment, the substrate of the borehole is concrete, and the anchoring means consists of steel or iron. In a further embodiment, the substrate of the borehole is steel, and the anchoring means consists of steel or iron. Preferably, the steel borehole has grooves.

A further subject of the invention is the use of brick powder as a filler in a multi-component system having a reactive resin component (A) and a hardener component (B) for increasing the performance of a fastening arrangement comprising a mortar mass prepared from the multi-component system and a fastening means, wherein the mortar mass prepared from the multi-component system is applied to a borehole filled with water.

In a preferred embodiment, the reactive resin component (A) comprises a radically curable compound as a reactive resin. All previously described embodiments apply to the radically curable compounds.

In an alternative embodiment, it is also possible for the reactive resin component (A) to comprise a curable epoxy resin. In these cases, an amine for hardening the epoxy resin is usually used as hardener component (B) in the multi-component system. Particularly preferred reactive resin components (A) and hardener components (B) are described in specifications WO 2020/058018 A1, WO 2020/058017 A1, WO 2020/058015 A1 and WO 2020/05816 A1, the contents of which are hereby incorporated into the present application.

The invention is explained in greater detail in the following with reference to a number of examples. All examples and drawings support the scope of the claims. However, the invention is not limited to the specific embodiments shown in the examples and drawings.

### EMBODIMENTS

Unless stated otherwise, all constituents of the compositions that are listed here are commercially available and were used in the usual commercial quality.

Unless stated otherwise, all % data given in the examples relate to the total weight of the composition described, as a calculation basis.

With regard to the PEG200DMA used, it should be noted that the number of ethylene glycol repeat units n is not unique. From the product designation, PEG200DMA, it can be concluded that a polyethylene glycol of molar mass 200 g/mol is based on the monomer. This corresponds for the formula HO—(—CH—CH₂—O—)—H to a value for n=4.2. Taking into account only the repeat units (—CH—CH₂—O—)˜ in the molar mass, n=4.5 can be specified. Since PEG200, from which PEG200 dimethacrylate is prepared, is a technical product, and the manufacturers of the cited dimethacrylate (Sartomer, Evonik as well as GEO Speciality Chemicals) indicate n=4 or n˜4 in their technical data sheets, primarily this specification is assumed.

### LIST OF THE CONSTITUENTS USED IN THE EXAMPLES AND REFERENCES (EXPLANATION OF ABBREVIATIONS) AS WELL AS THEIR TRADE NAMES AND SOURCES OF SUPPLY

TABLE 1
Constituents used in the reactive resin components (A)

| | Description |
|---|---|
| TUMA | Urethane methacrylate resin according |
| | to WO2019/007667, example A1 |
| UMA121 | Urethane methacrylate resin according |
| | to WO2019/007667, example C1 |
| E3BADMA | Dimethacrylate with bisphenol A |
| | alkoxylated in each case with 3 |
| | ethylene oxide units; trade name: SR348C (Sartomer) |
| bisGMA | Epoxy methacrylate resin |
| | Trade name: Ecocryl 05345 (Momentive) |
| HPMA | Hydroxypropyl methacrylate; trade |
| | name: Visiomer HPMA (Evonik) |
| 1,4-BDDMA | 1,4-Butanediol dimethacrylate; trade |
| | name: Visiomer 1,4-BDDMA (Evonik) |
| TCDDMA | Tricyclodecane dimethanol dimethacrylate; |
| | trade name: SR834 (Sartomer) |
| PEG200DMA | Polyethylene glycol(200)dimethacrylate; |
| | trade name: Visiomer PEG200DMA (Evonik) |
| DIPPT | Diisopropanol-para-toluidine (BASF) |
| Catechol | 1,2-Dihydroxybenzene; trade |
| | name: Catechol Flakes (Rhodia) |
| Tempol | 4-Hydroxy-2,2,6,6-tetramethylpiperidinyloxyl; |
| | trade name: 4-hydroxy-TEMPO (BASF) |
| tBBK | 4-tert-Butylcatechol; trade name: none (Aldrich) |
| F32 | Quartz sand F32 (Quarzwerke Frechen) |
| Secar 80 | Calcium aluminate cement (Kerneos SA) |
| TS720 | Fumed silica (Cab-O-Sil) |
| Millisil W3 | Quartz sand (Quarzwerkgruppe) |
| Ternal White | Calcium aluminate cement (Imerys) |

TABLE 2
Constituents used in the hardener components (B)

| | Description |
|---|---|
| BP35SAQ | Dibenzoyl peroxide in water |
| | (United Initiators) |
| BP40SAQ | Dibenzoyl peroxide in water |
| | (United Initiators) |
| Perkadox 20S | Mixture of dibenzoyl peroxide |
| | and gypsum (Nouryon) |
| Millisil W6 | Quartz (Quarzwerke Frechen) |
| Millisil W12 | Quartz (Quarzwerke Frechen) |
| RG4000 | Calcined aluminum oxide (Almatis) |
| Albawhite 10 | Barium sulfate (Sachtleben Minerals) |
| Axilat RH23 | Xanthan gum (Worlée) |
| Potassium dihydrogen | Potassium dihydrogen phosphate (Merck) |
| phosphate | |
| Aerosil 200 | Hydrophilic fumed silica (Evonik) |

Brick powders from different manufacturers were used as brick powder, which was sieved before use. Sieves (Retsch GmbH) with a corresponding mesh size were used for this purpose. The brick powders used are listed in the following table:

TABLE 3
Specification and designation of the brick powders used

| Manufacturer | Mesh size of the sieves | Designation | d₉₀ value |
|---|---|---|---|
| Pilosith | 0.500 mm | Z1.1 | 0.47 mm |
| GmbH | 0.710 mm | Z1.2 | 0.78 mm |
| | 0.850 mm | Z1.3 | 0.90 mm |
| | 0.250 mm and 0.355 mm | Z1.4 | 0.42 mm |
| Peter Stadler GmbH | 0.710 mm | Z2.1 | n.d. |
| | 0.850 mm | Z2.2 | n.d. |
| Kalkladen GmbH | 0.710 mm | Z3 | n.d. |

All brick powders were dried in the oven at a temperature of 120° C. for 48 hours. The brick powders have a water content of less than 0.2 wt. %.

### Preparation of the Reactive Resin Mixtures HA

All constituents of the relevant reactive resin mixture (HA) contained in Table 4 were added to a plastic beaker and stirred on a magnetic stirrer at room temperature until a solution was formed.

TABLE 4
Composition of the reactive resin mixtures HA1 to HA5 in wt. %

| | HA1 | HA2 | HA3 | HA4 | HA5 |
|---|---|---|---|---|---|
| TUMA | 45.0 | — | — | — | — |
| UMA-121 | — | 37.5 | 37.7 | — | — |
| E3BADMA | — | — | — | 70 | — |
| BisGMA | — | — | — | — | 40 |
| HPMA | 17.7 | 19.8 | 20 | 10 | — |
| 1,4-BDDMA | 34.6 | 40.0 | 40.15 | 17.3 | 28.8 |
| TCDDMA | — | — | — | — | 15.0 |
| PEG200DMA | — | — | — | — | 15.0 |
| DIIPT | 2.30 | 2.30 | 1.7 | 2.3 | 1.1 |
| Catechol | 0.27 | 0.27 | — | 0.27 | — |
| tBBK | 0.09 | 0.09 | — | 0.09 | 0.1 |
| Tempol | 0.04 | 0.04 | 0.45 | 0.04 | — |
| Total | 100.0 | 100.0 | 100.0 | 100.0 | 100.0 |

### Preparation of the Reactive Resin Components A1 to A19

To prepare the reactive resin components A1 to A19, the constituents indicated in the tables below were each combined and mixed in a dissolver (PC laboratory system, type 0.3-1) for 8 minutes at 3500 rpm under vacuum (100 mbar) with a 55 mm dissolver disk and an edge scraper.

TABLE 5
Composition of the comparative reactive resin component A1 and of the
reactive resin components A2 to A10 according to the invention in wt. %

| | | A1* | A2 | A3 | A4 | A5 | A6 | A7 | A8 | A9 | A10 |
|---|---|---|---|---|---|---|---|---|---|---|---|
| Reactive resin mixture HA1 | | 32.0 | | | | | | | | | |
| Brick | Z1.1 | — | 20.0 | 42.0 | — | — | — | — | — | — | — |
| powder | Z1.2 | — | — | — | 20.0 | 42.0 | — | — | — | — | — |
| | Z1.3 | — | — | — | — | — | — | — | 20.0 | 42.0 | — |
| | Z1.4 | — | — | — | — | — | — | — | — | — | 42.0 |
| | Z2.1 | — | — | — | — | — | 42.0 | — | — | — | — |
| | Z3 | — | — | — | — | — | — | 42.0 | — | — | — |

| | | | | | | | | | | |
|---|---|---|---|---|---|---|---|---|---|---|
| F32 | 42.0 | 22.0 | — | 22.0 | — | — | — | 22.0 | — | — |

| | |
|---|---|
| Secar 80 | 23.5 |
| TS 720 | 2.5 |

*not according to the invention

TABLE 6
Composition of the reactive resin components A11, A14, A16 and A18
not according to the invention and of the reactive resin components
A12, A13, A15, A17 and A19 according to the invention in wt. %

| | | A11* | A12 | A13 | A14* | A15 | A16* | A17 | A18* | A19 |
|---|---|---|---|---|---|---|---|---|---|---|
| Reactive resin mixture HA2 | | 34.5 | | | — | — | — | — | — | — |
| Reactive resin mixture HA3 | | — | — | — | 40.0 | | — | — | — | — |
| Reactive resin mixture HA4 | | — | — | — | — | — | 42.5 | | — | |
| Reactive resin mixture HA5 | | — | — | — | — | — | — | | 37.5 | |
| Brick | Z1.1 | — | 20.0 | 44.2 | — | — | — | — | — | — |
| powder | Z1.2 | — | — | — | — | — | — | 35.0 | — | 40.0 |
| | Z2.2 | — | — | — | — | 41.5 | — | — | — | — |

| | | | | | | | | | |
|---|---|---|---|---|---|---|---|---|---|
| F32 | 44.2 | 24.2 | — | 41.5 | — | — | — | 40.0 | — |
| Millisil W3 | — | — | — | — | — | 35.0 | — | — | — |
| Secar 80 | 18.5 | 18.5 | 18.5 | — | — | 20.0 | 20.0 | 20.0 | 20.0 |
| Ternal White | — | — | — | 15.0 | 15.0 | — | — | — | — |
| TS720 | 2.8 | 2.8 | 2.8 | 3.5 | 3.5 | 2.5 | 2.5 | 2.5 | 2.5 |

*not according to the invention

### Preparation of the Hardener Components (B)

The hardener components (B) used in the examples were prepared by all of the constituents indicated in Table 7 being added and mixed in a dissolver (type LDV 03-1) for 8 minutes at 3500 rpm under vacuum (pressure≤100 mbar) with a 55 mm dissolver disk and an edge scraper.

TABLE 7
Constituents of the hardener components B1 to B5 in wt. %

| | B1 | B2 | B3 | B4 | B5 |
|---|---|---|---|---|---|
| BP 35 SAQ | 35.0 | — | — | — | — |
| BP 40 SAQ | — | 55.0 | 14.6 | 7.3 | 2.4 |
| Perkadox 20S | — | 13.0 | — | — | — |
| Water | — | — | 20.8 | 18.4 | 18.7 |
| Millisil W6 | 44.0 | 31.0 | — | 39.75 | 56.0 |
| Millisil W12 | — | — | 62.3 | — | — |
| RG 4000 | 20.0 | — | — | — | 21.6 |
| Albawhite 10 | — | — | — | 31.35 | — |
| Axilat RH23 | | | | | 0.3 |
| Potassium dihydrogen | — | 0.25 | 0.2 | 0.2 | 0.2 |
| phosphate | | | | | |
| Aerosil 200 | 1.0 | 0.75 | 2.1 | 3.0 | 0.8 |

### Preparation of the Mortar Masses

To prepare the mortar masses, in each case one of the reactive resin components A1 to A4 and one of the hardener components B1 to B5 according to Table 8 were filled into hard cartridges in the specified volume ratio and applied via a static mixer (HIT-RE-M, Hilti AG) from the cartridges into a borehole filled with water.

### Determination of Load Values (88 Values)

To determine the bond strengths (load values) of the hardened mortar masses, a high-strength anchor threaded rod M12, which was doweled into a borehole filled with water having a diameter of 14 mm and a borehole depth of 72 mm in C20/25 concrete with the relevant chemical mortar mass at approx. 20° C., is used. The average failure load is determined by centrally pulling out the anchor threaded rod with close support. Five anchor threaded rods were each doweled and the load values were determined after a hardening time of 24 hours at room temperature. The mean load values determined in this case (average of the five measurements) are listed in Table 8 below.

TABLE 8
Mortar masses prepared from the reactive resin
component A and the hardener components B and
the load values determined in the pull-out tests

| | Epoxy resin | Hardener | Mixing ratio | Load value |
|---|---|---|---|---|
| Example | component A | component B | A:B | B8 in N/mm² |
| 1* | 1 | 1 | 5:1 | 16.04 |
| 2 | 2 | 1 | 5:1 | 16.90 |
| 3 | 3 | 1 | 5:1 | 17.46 |
| 4 | 4 | 1 | 5:1 | 18.33 |
| 5 | 5 | 1 | 5:1 | 19.51 |
| 6 | 6 | 1 | 5:1 | 18.77 |
| 7 | 7 | 1 | 5:1 | 18.94 |
| 8 | 8 | 1 | 5:1 | 17.42 |
| 9 | 9 | 1 | 5:1 | 20.44 |
| 10 | 10 | 1 | 5:1 | 20.28 |
| 11* | 11 | 1 | 5:1 | 14.13 |
| 12 | 12 | 1 | 5:1 | 15.58 |
| 13 | 13 | 1 | 5:1 | 16.04 |
| 14* | 1 | 2 | 10:1 | 16.74 |
| 15 | 3 | 2 | 10:1 | 18.55 |
| 16* | 14 | 3 | 3:1 | 8.17 |
| 17 | 15 | 3 | 3:1 | 10.88 |
| 18* | 16 | 1 | 5:1 | 14.43 |
| 19 | 17 | 1 | 5:1 | 17.70 |
| 20* | 18 | 4 | 3:1 | 12.09 |
| 21 | 19 | 4 | 3:1 | 13.31 |
| 22* | 18 | 5 | 3:1 | 17.36 |
| 23 | 19 | 5 | 3:1 | 18.44 |

*not according to the invention

The results of Table 8 show that the use according to the invention of brick powder as a filler in mortar masses for the preparation of chemical dowels can achieve an increase in the load values in the water-filled borehole compared to the reference examples which do not contain any brick powder.

The table below shows the constituents of a multi-component system comprising at least one epoxy resin in the reactive resin component (A) and at least one amine as a hardener for the epoxy resin in the hardener component (B).

The reactive resin components (A), the hardener components (B), the multi-component system prepared from these two components, and the corresponding mortar mass were prepared analogously to the experimental part of the specification WO 2020/058018 A1. The application of the mortar masses and the pull-out tests took place as already described above.

TABLE 9
Composition of the multi-component systems with reactive resin components
(A) comprising at least one epoxy resin and hardener components (B)
comprising at least one amine (*not according to the invention)

| | | Example | | | | | | | |
|---|---|---|---|---|---|---|---|---|---|
| | Constituent | 24* | 25 | 26* | 27 | 28* | 29 | 30* | 31 |
| Reactive | Araldite GY 240 | 35 | 35 | 35 | 35 | 35 | 35 | 35 | 35 |
| resin | Araldite GY 282 | 18.8 | 18.8 | 18.8 | 18.8 | 18.8 | 18.8 | 18.8 | 18.8 |
| component | Araldite DY 026 | 6.7 | 6.7 | 6.7 | 6.7 | 6.7 | 6.7 | 6.7 | 6.7 |
| (A) | Araldite DY-T-CH | 6.7 | 6.7 | 6.7 | 6.7 | 6.7 | 6.7 | 6.7 | 6.7 |
| | Millisil W12 | 30 | — | 30 | — | 30 | — | 30 | — |
| | Z2.1 | — | 30 | — | 30 | — | 30 | — | 30 |
| | CabOSil TS 720 | 2.7 | 2.7 | 2.7 | 2.7 | 2.7 | 2.7 | 2.7 | 2.7 |
| | EEQ [g/eq.] | 235 | 235 | 235 | 235 | 235 | 235 | 235 | 235 |
| Hardener | Ca(NO ₃)₂ | — | — | 1.9 | 1.9 | — | — | — | — |
| component | (80% in glycerol) | | | | | | | | |
| (B) | Beckopox SEH 2627 | 70 | 70 | — | — | — | — | — | — |
| | Novares LS500 | — | — | — | — | 23.8 | 23.8 | — | — |
| | mXDA | — | — | 36.8 | 36.8 | 50 | 50 | 8 | 8 |
| | Dytek A | — | — | — | — | — | — | 32.2 | 32.2 |
| | Phenolite TD-2131 | — | — | — | — | — | — | 10.2 | 10.2 |
| | Millisil W12 | 24.3 | 24.3 | 57.3 | 57.3 | 23.2 | 23.2 | 42.8 | 42.8 |
| | CabOSil TS720 | 2.7 | 2.7 | 4 | 4 | 3 | 3 | 4.4 | 4.4 |
| | Ancamine K54 | 3 | 3 | — | — | — | — | 2.4 | 2.4 |
| | AHEQ [g/eq.] | 76 | 76 | 92 | 92 | 68 | 68 | 74 | 74 |
| Load value | | 22 | 24 | 20 | 21 | 20 | 23 | 19 | 20 |
| B8 [N/mm²] | | | | | | | | | |

1. A reactive resin component (A), having at least one radically curable compound as a reactive resin, wherein the reactive resin component (A) contains brick powder.

2. The reactive resin component (A) according to claim 1, wherein the reactive resin component (A) contains at least 10 wt. % of brick powder based on the total weight of the reactive resin component (A).

3. The reactive resin component (A) according to claim 2, wherein the reactive resin component (A) contains 20 to 60 wt. % of brick powder based on the total weight of the reactive resin component (A).

4. The reactive resin component (A) according to claim 1, wherein the brick powder has a d₉₀ value of ≤0.90 mm.

5. The reactive resin component (A) according to claim 4, wherein the brick powder has a d₉₀ value in the range of 0.9 mm to 0.2 mm.

6. The reactive resin component (A) according to claim 1, wherein the brick powder has a water content of less than 1 wt. %.

7. The reactive resin component (A) according to claim 1, wherein the at least one radically curable compound is selected from the group consisting of compounds based on urethane(meth)acrylate, compounds based on epoxy(meth)acrylate, methacrylates of alkoxylated bisphenols, compounds based on further ethylenically unsaturated compounds, and combinations thereof.

8. The reactive resin component (A) according to claim 1, wherein the reactive resin component (A) comprises at least one reactive diluent.

9. The reactive resin component (A) according to claim 1, wherein the reactive resin component (A) further comprises an inhibitor, an accelerator and/or further additives.

10. A multi-component system comprising a reactive resin component (A) according to claim 1 and a hardener component (B) comprising a hardener for the reactive resin.

11. The multi-component system according to claim 10, wherein the hardener comprises a peroxide.

12. The multi-component system according to claim 10, wherein the multi-component system is a two-component system.

13. A method for the chemical fastening of an anchor in boreholes or for structural bonding, the method comprising:
applying the multicomponent system according to claim 10 to a borehole.

14. A brick powder in a multi-component system, having a reactive resin component (A) and a hardener component (B) for increasing the performance of a fastening arrangement comprising a mortar mass prepared from the multi-component system and a fastener, wherein the mortar mass prepared from the multi-component system is applied to a borehole filled with water.

15. The brick powder according to claim 14, wherein the reactive resin component (A) comprises a radically curable compound as a reactive resin.
